(19) United States
(12) Patent Application Publication
(10) Pub. No.: US 2013/0066721 A1
(43) Pub. Date: Mar. 14, 2013

(54) METHODS, SYSTEMS, AND COMPUTER READABLE MEDIA FOR NOTIFICATION OF CHANGES IN ONLINE PRICES WITHIN A VISUAL BOOKMARKING ORGANIZATIONAL WEBSITE

(71) Applicant: Oded BERKOWITZ, Fort Lee, NJ (US)

(72) Inventor: Oded BERKOWITZ, Fort Lee, NJ (US)

(21) Appl. No.: 13/476,582

(22) Filed: May 21, 2012

Related U.S. Application Data
(60) Provisional application No. 61/618,398, filed on Mar. 30, 2012.

(51) Int. Cl. G06Q 30/02

(52) U.S. Cl. 705/14.55

(57) ABSTRACT

The subject matter described herein includes methods, systems, and computer-readable media for providing an indication of a change in an online price. According to one method, a request for an indication of a change in an online price of a product or service is received from a user. A current price of the product or service is provided and a target price of the product or service is received from the user. A change in the price of the product or service is detected and an indication of the change in the price of the product or service is generated.

### PRIORITY CLAIM

This application claims the benefit of U.S. Provisional Patent Application Ser. No. 61/618,398 filed Mar. 30, 2012; the disclosure of which is incorporated herein by reference in its entirety.

### BACKGROUND OF THE INVENTION

1. Field of the Invention

The present invention relates to providing notification of decreases in online prices and more particularly to providing such notifications as part of a visual bookmarking organizational website.

2. Description of the Related Art

Systems for being notified when a product decreases in price have been sought after for many years. Even prior to the migration to e-commerce and online shopping, customers desired a means of knowing when an item they wished to purchase would be available for a more desirable price. Often, that meant returning to stores repeatedly to monitor the price of products to see whether there was a sale on the specific item, a general decrease caused by a change in supply and demand, or the introduction of a new model. In some ways, this pre-digital system carried over into the e-commerce revolution.

At first, customers shopping for products online generally continued to operate in the manner described. Customers visited sites, identified products they wanted to purchase and then evaluated whether they were willing to pay the online retailer's asking price. If they were not willing to pay this price, they tended to continue visiting the site periodically to monitor the price in an attempt to make the purchase when the price had been modified and was agreeable to them.

Acknowledging this problem, online retailers and services began attempting to address the issue. They implemented systems that would allow customers to specify a target price, at which they would be willing to purchase a given product, whereupon they would be sent electronic mail notifying them that their target price had been reached. At that point a customer could decide if they would now be willing to make that purchase at the new, lower price. These systems were a first step in addressing the problem, but have never since managed to fully rectify the problem or provide customers with a service that fully addresses their needs. Entities that have implemented systems that attempt to address these issues generally fall into two categories: specific e-commerce retailers and “universal” systems. Each has addressed aspects of the issue but neither has succeeded in doing so fully. What follows will be a discussion of the shortcomings of each implementation, beginning with specific e-commerce retailers.

E-commerce retailers began providing customers with the option to be notified when the price of a product dropped as growth in the online shopping space increased. It was, and is, a means for retailers to retain customers who might otherwise take advantage of the ease and convenience of contemporary online shopping, abandoning the original retailer's site in search of a more favorable price point on the product. Retailers that implemented such systems modeled them on patterns of consumer behavior observed in brick and mortar stores, but failed to recognize the fundamental changes present in online consumer behavior. An in-store consumer might, due to proximity, relative convenience, or brand loyalty, decide to return to a store on multiple occasions in the hope of purchasing at their target price. The online consumer, however, exhibits a dramatically different behavior. The online consumer expects convenience and ease in making purchases and has little retailer loyalty.

This model has failed to play into any of the expectations of the modern, savvy, online consumer. It expects consumers to limit themselves to a given retailer and wait for the price of the product from that specific retailer to drop, something online consumers are not willing to do. Additionally, such systems force consumers to have multiple systems for monitoring the prices of multiple items from multiple different e-commerce retailers, something the average consumer is not willing to maintain. Such a system decentralizes all management of said notifications, making it untenable. On the subject of “management,” many retailer's systems include no means of managing or modifying existing notifications. Thus, if a user would like to modify the price threshold, they must set a new notification and ultimately receive redundant notifications.

To engage with such systems, generally, a user must visit a retailer's website, and identify a product that they would like to purchase. They must then choose all options for the product such as color and size, and then find the option to set a notification when the price of the item drops. The user must then specify their target price and then enter their email address. Often the user must then check their email to confirm the email address, whereupon they are directed back to the retailers site to see a confirmation message that the alert has been set. Thereafter, there is no system for managing notifications on different products or viewing them in an organized fashion. It thus becomes apparent that price notification systems as implemented by traditional e-commerce retailers have significant shortcomings which render them unusable for the average consumer.

Seeing the shortcomings and failures of e-commerce retailers' price notification systems, “universal” price notification websites began to emerge. These websites attempt to succeed where traditional e-commerce retailers' systems failed by better matching online consumer behavior. These websites recognize the fact that the modern online consumer is savvy, purchase-goal-oriented, expects ease in purchasing, and has little retailer loyalty. They generally address this by implementing systems that work in one of two ways.

In the first model, users visit the website of the service provider, usually create an account, and then either enter a search or browse products by category. The significant point to be noted here is that the user must go to the site of the service provider in order to create a price notification on a given item. Searching for products occurs within the website of the service provider. The user then browses through the products returned from the service provider's database. If and when the user finds the product they are looking for they may either be redirected to purchase the product from the original retailer's website or request to be notified when the price of the item reaches a certain target price. This is accomplished by entering a “target price,” defined as the price the user would be willing to pay for the item, and thus, would like to be notified when the product reaches that threshold. In other words, if the product is currently available from a site affiliated with the service provider for $100 and the user would be willing to pay $90 for said product, they would enter $90 as their “target price” to receive an email notification when the product is available from that retailer for $90 or less. Thereafter, the user would receive an email upon the product reaching the target price. At that point the user could choose to purchase the product at that price point or set a new target price, whereupon the process would begin from the beginning again.

These conventional sites work very specifically with affiliates and return results for product searches based on affiliate relationships. If the service provider has affiliate relationships with stores X, Y, and Z, who carry the product as part of their e-commerce platform, but not store W which also offers said product, only results from stores X, Y, and Z would be displayed. This highlights the first major shortcoming of such service providers. Users are limited in the number and variety of stores from which they can select products to receive price notifications. If a given product is only available from a store with which the service provider does not have a relationship, the user will not have the option of receiving a price notification on that product.

The second shortcoming of such systems is that they necessitate that users make an active effort to navigate to their site when they would like to set a price notification on a given product. Here too, these service providers fail to recognize a fundamental characteristic of online consumer behavior, namely that users value convenience and ease of use. Thus, the extra step and break in workflow of requiring users to navigate to a specific site as a prerequisite to setting a price notification is inconvenient and undesirable for the average user.

In the second model, users visit the website of the service provider and sign up for the service. Thereupon, they install a bookmarklet on their web browser's bookmarks bar. This bookmarklet operates externally, meaning users need not be on the service provider's website to operate the bookmarklet. In such systems, users are directed to visit websites containing products and identify a product that they would like to purchase at a price lower than its currently listed price. The user then uses the bookmarklet to indicate to the system that they would like to set a price notification on said product. Detection of price generally occurs in one of two ways: manually or automatically. In the manual method, the user must use their pointing device to highlight the text on the page that contains the price of the item. This indicates to the system where the price div (HTML division) tag is in the HTML document corresponding to the page. When the bookmarklet is clicked by the user, the system saves the location of the price div for that page for that user to its database. In most cases, upon, clicking the bookmarklet the user is taken to the website of the service provider and asked to indicate the preferred target price. The second method of price detection is via an automated attempt by the service provider to, upon the user clicking the bookmarklet, automatically detect HTML tags in the document indicating where the price is and infer from that what the price of the product is. The system will then take the user to a page on the service provider's website where they can set the target price. Both methods have significant shortcomings. The first method creates a poor user experience as users must always remember to first highlight the price or they are taken to the service provider's homepage. Additionally, the first method creates unnecessary strain on the web server that checks the product prices because each product from each user on each website is treated as a separate entity. The second method is highly inaccurate as HTML tags for price are used very inconsistently by ecommerce websites, which leads to a significant margin of error.

Another flaw in the second model as a whole is that it inaccurately surmises online consumer behavior. It assumes that the user has an interaction mode of “savings.” In other words, the user decides that they would like to engage in saving money and will now go to websites containing the things they want to buy and use a money-saving bookmarklet. The user later decides that they would like to visit their money-saving website to manage all the places where they previously decided they wanted to save money. This interaction model is flawed in that it fails to acknowledge the consumer preference for convenience and catch-all online solutions that integrate with their current online interaction patterns.

Accordingly, there is a need to overcome the shortcomings described above in order to provide an improved method for providing an indication of a change in an online price.

### SUMMARY AND OBJECTS OF THE INVENTION

Accordingly, it is an object of the invention to provide an indication of a change in an online price as part of a visual bookmarking organizational website. The subject matter described herein improves upon all other systems most significantly is in its integration with the visual bookmarking system. The subject matter described herein most accurately reflects the behavior patterns of the modern online consumer. It does so by recognizing that consumers do not enter any sort of “savings” mode whereupon they go on a streak of setting price notifications using a dedicated price notification system. The contemporary Internet user is constantly browsing numerous web pages, some containing news articles, others images, still others products etc. The subject matter described herein provides a simple and convenient means of saving all of these pages/clippings in an organized and efficient manner. In order for price notifications to truly be useful and to the user it must be integrated with an all encompassing system that may be used to organize all of the products and other pages that the user is saving. By integrating price drop alert into the clipix.com visual bookmarking system, users are afforded the convenience of being able to conveniently set price notifications in a manner that matches their pre-existing interaction patterns.

Those and other objects and features of the present invention are accomplished by a tangible computer readable medium having stored thereon computer executable instructions that, when executed by the processor of a computer, performs steps. The steps include receiving, from a user, a request for an indication of a change in an online price of a product or service. A current price of the product or service is provided and a target price of the product or service is received from the user. A change in the price of the product or service is detected and an indication of the change in the price of the product or service is generated.

With those and other objects, advantages, and features of the invention that may become hereinafter apparent, the nature of the invention may be more clearly understood by reference to the following detailed description of the invention, the appended claims, and the several drawings attached herein.

### BRIEF DESCRIPTION OF THE DRAWINGS

FIG. 1 is a flow chart of exemplary steps for providing a an indication of a change in a online price in accordance with an embodiment of the subject matter described herein;

FIG. 2 is a block diagram of an exemplary system for providing a an indication of a change in a online price in accordance with an embodiment of the subject matter described herein;

FIG. 3 is an exemplary screenshot of a panel for adding a clip in accordance with an embodiment of the subject matter described herein;

FIG. 4 is an exemplary screenshot of a price drop alert entry in a panel for adding a clip in accordance with an embodiment of the subject matter described herein;

FIG. 5 is an exemplary screenshot of a panel for adding a clip including an activated price drop alert feature in accordance with an embodiment of the subject matter described herein;

FIG. 6 is an exemplary screenshot of a panel for adding a clip when a clip has been updated in accordance with an embodiment of the subject matter described herein;

FIG. 7 is an exemplary screenshot of a clipboard containing clips with price drop alerts set in accordance with an embodiment of the subject matter described herein;

FIG. 8 is an exemplary screenshot of an expanded view of a clipboard containing clips with price drops alerts set in accordance with an embodiment of the subject matter described herein;

FIG. 9 is an exemplary screenshot of an individual clip with a price drop alert set in accordance with an embodiment of the subject matter described herein;

FIG. 10 is an exemplary screenshot of an interface for one of editing a clip, editing a price drop alert, or creating a new price drop alert in accordance with an embodiment of the subject matter described herein; and

FIG. 11 is an exemplary screenshot of various notifications including a notification that a target price has been reached in accordance with an embodiment of the subject matter described herein.

### DETAILED DESCRIPTION OF THE PREFERRED EMBODIMENTS

Several preferred embodiments of the invention are described for illustrative purposes, it being understood that the invention may be embodied in other forms not specifically shown in the drawings.

Such a system of price notifications addresses a majority of the shortcomings of the previously discussed models of price notification. In relation to the first model, the subject matter described herein recognizes the difference in online consumer behavior and the need for a centralized system of price notifications rather than one that is distributed across different e-commerce retailers and proprietary to said retailers. It avoids the need for users to enter email addresses for “one-time-use” across many different channels, and instead allows users to use one system for all channels. Unlike “one-time-use” retailer price notifications which cannot be managed or modified, the subject matter described herein allows for continuous control and management.

Regarding the “universal” systems, the present invention significantly improves upon the prior art. The subject matter described herein is not limited only to retailers with which there may be affiliations, but is capable of supporting price drop alert from a majority of retailers. This lends greater utility to the system as it is not limited in the products for which price drop alert can be set. There is no database of products that the subject matter described herein can support, rather, users of the subject matter described herein may “Clip” and set a price drop alert for any product. This also means that users are not performing a search on the site and therefore may browse and perform search queries as they normally would in their regular use of the Internet. Perhaps most significantly, the model described herein acknowledges the consumer preference for convenience. By not asking the consumer to visit clipix.com in order to set a price drop alert, the subject matter described herein significantly improves upon the user experience of the first model.

Vis a vis the second model, the subject matter described herein again improves upon the prior methodology. Whereas the prior methods either ask a user to highlight the price of the item (leading to poor user experience and inefficient database and server use) or attempt to guess where the price field is on the page using HTML tags (leading to inaccurate prices or no price detected at all) the subject matter described herein ensures an extremely high level of accuracy and success rate by employing real people to find and enter the correct price HTML div in the database for product pages. This ensures a very positive user experience and an efficient use of server resources (in allowing the server to aggregate users setting notifications on the same site). Additionally, the subject matter described herein allows users to perform the entire process of setting the alert while remaining on Website Z, never forcing them to go to the site to set the alert.

The subject matter described herein addresses all of the aforementioned shortcomings of prior solutions to create a product that is unique to the marketplace in its utility and ingenuity. The subject matter described herein is a visual bookmarking website that enables users to save the URLs of pages that they see online as visual bookmarks containing a link to the original source, a description of that which was seen, an image from the page, a price (if the item is a product), and comments from other users of the system. In the system these items are referred to as “Clips.” Clips are added using a bookmarklet. Upon creating an account with the site users place a bookmarklet on their browser's bookmarks bar. This bookmarklet is operated externally, meaning on other websites. Thus, if a user sees an article that they want to remember on website Z they would click the bookmarklet which would launch a panel on site Z allowing the user to send the content to their account.

This panel operates by providing the user with an interface for selecting one of the images that was automatically found on the page. This image will visually represent the Clip in the system. The description of the clip is pre-populated in a text field using the HTML Title element of the page, but may be edited by the user. The user must select a category to which they would like to add the clip. Categories are herein referred to as clipboards. Users may be provided with six default clipboards upon opening an account. These may be edited or deleted and an unlimited number of custom clipboards may be created. Also present in the panel is a price field where the currency being used on the page and a pre-populated price appear. The price field is pre-populated accurately in the vast majority of cases. This may be accomplished by a human team that identifies the HTML div containing the correct price for the website being clipped. Beside the price field is a checkbox relating to the words “Price drop alert,” which will be discussed in greater detail later. The user may then select check-boxes to share the item that will be clipped via their social media channels of choice. Finally, the user may “Clip” the item by clicking the “Clip” button at the bottom of the panel. This all occurs on external website Z. The clip is sent to the user's account and no further action is required on the part of the user. They may continue using website Z.

Next, an overview of a method of setting and using the aforementioned “Price drop alert” feature within a visual bookmarking system will be described. If a user desires to be notified when the price of the product drops by an amount that they specify, they may do so by selecting a price drop alert option when a check-box beside the words “Price drop alert” is clicked. After doing so, an interface slides up from the bottom of the same panel to allow the user to initiate this functionality.

The user is then presented with an interface containing the current price and two fields that may be filled out relating to target price. The user may enter a target price indicating that they would like to be notified when the product is listed at the current online retailer for the price indicated. Updating the target price also updates other fields indicating the percentage by which the price must drop to receive a notification. These fields always update simultaneously and remain in sync so a user may also indicate the percentage by which the price must drop before they receive a notification. Conversely, changes to the percentage field will simultaneously adjust the price field. The user may then save the price drop alert and is taken back to the regular clip panel in its first stage. The notable difference is that where the selector for Price drop alert was previously is now a check box with the words “Alert: $XX” providing simple feedback on the price point that was set by the user for a price notification. The user also has the option to edit the alert (returning the user to the “Price drop alert” panel) or turn it off. Once the user clicks the “Clip” button, the price drop alert is set and no further action is required on the part of the user. The price drop alert for the product is stored in the clipix.com database and associated with the user who is requesting it. The database efficiently groups clippings by different users from the same website, allowing it to minimize requests to the server to check the price. The server uses an automated system to consistently check the price on Website Z's HTML page that contained the clip. This may occur via an outward call from the clipix.com server to website Z's server or via an API provided by website Z.

Once the product with price drop alert set has been clipped, it appears on the users clipboard on clipix.com just like any other clip. However, it may have three visible statuses: 1. An orange circle in the lower left-hand corner indicating that price drop alert is set and running for this product. In alternate, larger, views of the clip there is a price flag (containing the live price of the item) outlined in orange indicating the same thing. In both cases, if the user hovers the mouse over the orange indicator they will be informed of the target price that they set as well as the percentage that the price must drop to reach the target in the form of a browser-generated tooltip. 2. A green price flag containing the current price of the item when the price threshold has been reached. Hovering the mouse over this indicator informs the user that their target price has been reached. 3. An orange question mark appears on the clip when the source URL of the clip can no longer be found by the system. This may occur when the server of website Z hosting the source page is experiencing technical difficulties or the page has been removed from the server altogether and can no longer be found at its original location.

Even after a price drop alert has been set on a clip a user may still choose to edit their target price or percentage by choosing to “edit” the clip. In the “edit” mode of a given clip the user has access to all of the controls that were originally present when first setting the price drop alert. Setting a new target price or percentage updates the clipix.com database to reflect the change and notify the user of a price drop accordingly.

When the threshold of a given clip with price drop alert set is crossed, a user may be notified in two ways simultaneously. First, the user may be notified via an internal notification system that may be accessed on the user account page upon logging in to clipix.com and, second, by email to the email address the user provided upon creating an account. The notification indicates that the price drop alert that was set on a given clip has been reached. It also indicates what the original price was, what the current price is, and how great the percentage of change there is between those two prices. The user also has the option of viewing the clip on clipix.com or going directly to the original source of the clip to view or purchase the product that has now reached the target price.

A price drop alert notification may also be applied to clips on shared clipboards (Syncboards [TM])—or any other type of board—where multiple members of the clipboard would receive a notification upon the target price being reached. It could also be applied to a clip on a private clipboard, visible only to the user. It could be applied to clip on a clipboard that is only visible to select clipix.com members. It could be applied to a clip on a clipboard that is visible to all clipix.com members or the general public. Users who are able to view a price drop alert may be able to comment on the clip or on the alert. Users could set price drop alert notifications on behalf of another user. Users could use price drop alert in relation to other clips, requesting that the system only notify when another clip has reached a given threshold. Users could use price drop alert in relation to other clips, as it relates to comparison shopping. Price drop alert could be applied to an entire class of clips or to a specific product SKU or unique identifier, allowing the system to evaluate the clip as it relates to all similar or identical products.

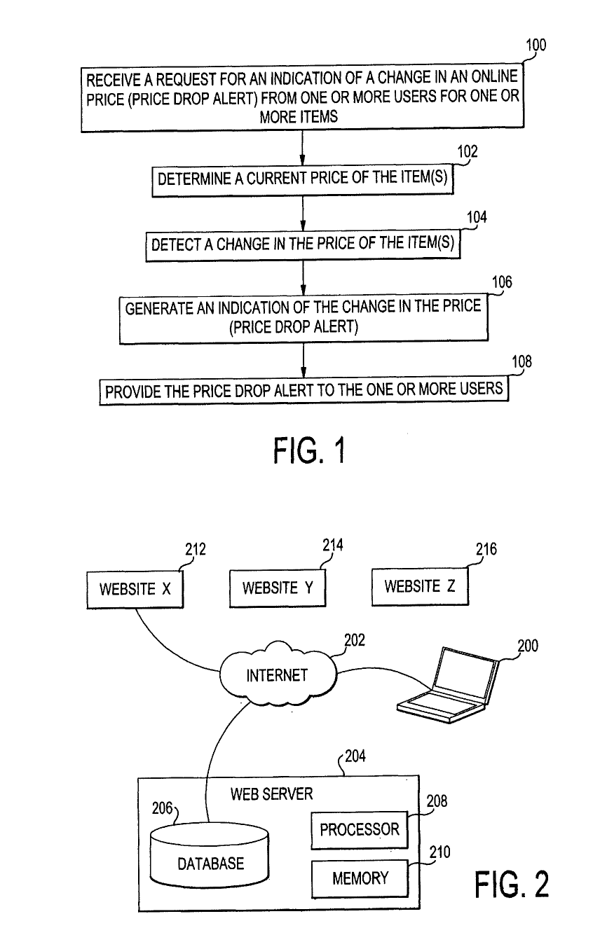

FIG. 1 is a flow chart of exemplary steps for providing an indication of a change in a online price in accordance with an embodiment of the subject matter described herein. Referring to FIG. 1, at step 100, a request for an indication of a change in an online price (i.e., a price drop alert) is received from one or more users for one or more items. For example, a first user may request a price drop alert for a television sold by website X, a second user may request a price drop alert for a microwave oven also sold by website X, and a third user may request a price drop alert for the same television as the first user sold be website X. In other embodiments, price drop alerts may be requested from a variety of source websites through the clipboard interface on a website according to the subject matter described herein. As will be described in greater detail below, a user of the clipboard website may browse other websites and, upon finding a product or service he is interested in, may “clip” that product or service (which is linked to the source website's page) to his clipboard. The user can then check a checkbox for that clip indicating that he requests a price drop alert for the product associated with that clip.

At step 102, a current price of the item is determined. For example, a human team may identify the HTML div containing the correct price for the website being clipped. In one scenario, the current price of the television is $100 and the current price of the microwave oven is $50.

At step 104, a target price of the item is received from the user. For example, the first user may express his target price in terms of either absolute value (e.g., dollars) or as a percentage of the current price (e.g., 10% discount). The second user may request a price drop alert when the price reaches $57.50 or a 5% drop. The third user may request a price drop alert when the price reaches $85 or a 15% drop.

At step 106, a change in the price of the item is detected. For example, rather than making separate page requests to website X to determine whether the price of each items subject to a price alert has been changed, the subject matter described herein combines multiple price drop alert requests into fewer requests to the source website and splits the results out among users. Thus, continuing the exemplary scenario, the price drop alerts for the first and the third users for the television sold by website X may be combined into a single request. It may then be determined that the price of the television has dropped by $11.00, or 11% and that the value of the microwave oven has not changed.

At step 108, an indication of the change in the price (i.e., a price drop alert) may be generated. For example, a green indicator may be generated for the clip associated with the first user because his target price has been reached (i.e., 11% drop>10% target). However, for the same product, an orange indicator may be generated for the clip associated with the third user because, even though the price has changed, the target price has not been reached (i.e., 11% drop<15% target). Lastly, no change indicator is generated for the clip associated with the second user because the price has not changed (e.g., an orange indicator may be maintained.)

At step 110, the price drop alerts may be provided to the users. As described above with respect to the exemplary scenario, the price drop alert(s) generated in step 108 may be provided to users in a variety of ways. For example, price drop alerts may be presented as orange or green circles or flags which are overlaid on top of associated clips within a clipboard interface. Alternately, price drop alerts may be emailed to the user or via an internal messaging system.

FIG. 2 is a block diagram of an exemplary system for providing an indication of a change in an online price in accordance with an embodiment of the subject matter described herein. Referring to FIG. 2, computer 200 may be any computer (e.g., laptop, desktop, etc.) for connecting to an online clipboard website and one or more other source websites. Computer 200 may be connected to the internet 202 for communicating with a web server 204 according to the subject matter described herein. Web server 204 includes a database for storing user IDs, email addresses, and any other clipboard-related information such, but not limited to, price drop alerts, current prices of items for which a price drop alert has been requested, target prices of items for which a price drop alert has been requested, cached images of products, and descriptions of products associated with clips.

Web server 204 also includes a processor 208 and memory 210 for storing non-transitory computer-readable instructions that, when executed by processor 208, perform steps such as those shown in FIG. 1. Also connected via Internet 202 are one or more source websites. In the example shown in FIG. 2, website X 212 (e.g., Amazon.com), website Y 214 (e.g., gap.com), and website Z 216 (e.g., walmart.com), which may be browsable by computer 200. Additionally, web server 204 may communicate with websites 212-216 via an outward call from the clipix.com server to website Z's server or via an API provided by each website 212-216.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

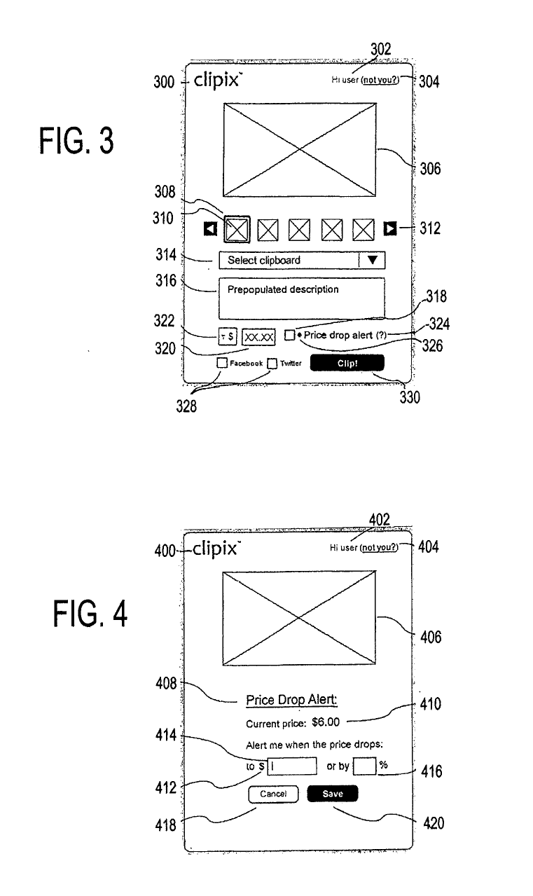

FIG. 3 is an exemplary screenshot of a panel for adding a clip in accordance with an embodiment of the subject matter described herein. It is appreciated that the information and functionality illustrated in FIG. 3, as well as FIGS. 4-11, may be presented in the exemplary format(s) shown or in any number of other designs without departing from the scope of the subject matter described herein. The panel for adding a clip shown in FIG. 3 may operate on a target website, external to server. The panel may be activated by a user clicking a “clip” bookmarklet on their browser's bookmark toolbar. Clicking the bookmarklet activates JavaScript functionality, making a call to the web server and loading the JavaScript panel on top of the HTML document of the target website. Referring to FIG. 3, panel 300 includes a feedback indicator 302 for indicating a currently logged in user. If no user is currently logged in, mechanism 304 allows for a user to log in, log out, or change users by providing appropriate credentials. Screen portion 306 shows the currently selected image associated with a clip, in a large format, that may be retrieved from a target website's HTML document. Indicator 308 provides an indication of the currently selected thumbnail image, for example, by outlining or highlighting the currently selected image. The currently selected thumbnail image 310 is shown along with zero or more additional thumbnail images, where mechanism 312 allows for scrolling through the thumbnail images pulled from the target website's HTML document.

Selector 314 allows for choosing which clipboard (category) the clip will be uploaded to and screen portion 316 includes a free-form field for entering a clip description that may be pre-populated with a description. A two stage selector 318 may allow for selecting whether a price drop alert will be activated for the current product. For example, two stage selector 318 may include a check box where a check indicates an activated price drop alert and an absence of a check indicates that no price drop alert should be activated. Pre-populated price value field 320 may indicate a price of the product or service associated with the price drop alert. Selector 322 may allow for choosing a currency associated with the price of the product or service and tooltip 324 may provide an explanation of the price drop alert, which may be activated, for example, upon hovering a cursor over the indicated area. Indicator 326 may provide an indication of the status of the price drop alert. For example, an orange circle may indicate that a price drop alert is active but the target price drop has not yet been reached. When the target price has been reached, the orange circle may become a green circle. One or more two-stage selectors 328 may allow for choosing whether the clip will be shared on various social media websites, such as Facebook or Twitter. Finally, button 330 may allow for submitting the clip 300 and uploading the clip 300 to a database, where the information may be associated with a user ID of the logged in user.

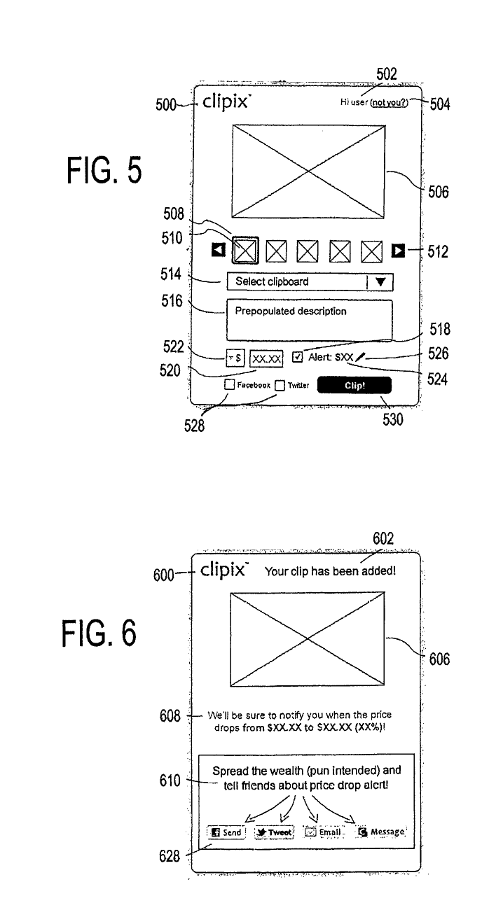

FIG. 4 is an exemplary screenshot of a price drop alert entry in a panel for adding a clip in accordance with an embodiment of the subject matter described herein. Activating the two-stage selector 318 for a price drop alert causes the new content shown in FIG. 4 to be displayed (e.g., slide up from the bottom of the panel 300). Upon saving or canceling data entry, the new content may slide back down toward the bottom of the panel 300, revealing FIG. 5 which will be described later. Referring to FIG. 4, panel 400 includes a feedback indicator 402 for indicating a currently logged in user. If no user is currently logged in, mechanism 404 allows for a user to log in, log out, or change users by providing appropriate credentials. Screen portion 406 shows the currently selected image associated with a clip, in a large format, that may be retrieved from a target website's HTML document. Indicator 408 may provide an indication of the user's current location in the clip upload and price drop alert setting process. Indicator 410 may indicate a price of the product or service which was populated or modified in FIG. 3. For example, the current price of the selected product may be $6.00. The currency in which the price drop alert feature will be stored into the database may be indicated by indicator 412.

Free-form field 414 may allow for entry of a user's target price. Typically, the target price will be less than the current price. The target price may be automatically, instantly, and continuously synchronized with percentage field 416, which indicates the percentage difference between the target price and the current price. Thus, if the target price entered is $5.40, then field 416 would indicate that this corresponds to a 10% price drop. Likewise, a user can enter a price drop in percentage terms in field 416 (e.g., 10%) and field 414 may be automatically populated with the corresponding target price (e.g., $5.40). Button 418 allows the user to cancel the setting of the price drop alert and return to FIG. 3. Button 420 allows the user to save the values entered in the HTML and JavaScript panel shown in FIG. 4. The price drop alert may be uploaded and stored in the database upon clipping the clip as will be described in FIG. 5.

FIG. 5 is an exemplary screenshot of a panel for adding a clip including an activated price drop alert feature in accordance with an embodiment of the subject matter described herein. The panel shown in FIG. 5 may be activated when the user clicks a “clip” bookmarklet on their browser's bookmark toolbar. Clicking the bookmarklet activates JavaScript functionality and makes a call to web server 204 and loads the JavaScript panel on top of the HTML document of the source website. This stage of the panel/price drop alert setting process displays a clip on which a price drop alert has been set. Referring to FIG. 5, panel 500 includes a feedback indicator 502 for indicating a currently logged in user. If no user is currently logged in, mechanism 504 allows for a user to log in, log out, or change users by providing appropriate credentials. Screen portion 506 shows the currently selected image associated with a clip, in a large format, that may be retrieved from a target website's HTML document. Indicator 508 provides an indication of the currently selected thumbnail image, for example, by outlining or highlighting the currently selected image. The currently selected thumbnail image 510 is shown along with zero or more additional thumbnail images, where mechanism 512 allows for scrolling through the thumbnail images pulled from the target website's HTML document.

Selector 514 allows for choosing which clipboard (category) the clip will be uploaded to and screen portion 516 includes a free-form field for entering a clip description that may be pre-populated with a description. A two stage selector 518 may allow for selecting whether a price drop alert will be activated for the current product. For example, two stage selector 518 may include a check box where a check indicates an activated price drop alert and an absence of a check indicates that no price drop alert should be activated. Pre-populated price value field 520 may indicate a price of the product or service associated with the price drop alert. Selector 522 may allow for choosing a currency associated with the price of the product or service. Indicator 524 shows the value of the target price as specified by the user. This value may be saved to the database in association with the user ID and website source URL upon clicking the clip button 530. Indicator 526 may allow for editing the currently selected price drop alert target value. If clicked, the user maybe directed back to FIG. 4, where the user may edit previously specified values. When the target price has been reached, the orange circle may become a green circle. One or more two-stage selectors 528 may allow for choosing whether the clip will be shared on various social media websites, such as Facebook or Twitter. Finally, button 530 may allow for submitting the clip 500 and uploading the clip 500 to a database, where the information may be associated with a user ID of the logged in user.

FIG. 6 is an exemplary screenshot of a panel for adding a clip when a clip has been updated in accordance with an embodiment of the subject matter described herein. Referring to FIG. 6, panel 600 includes a feedback indicator 602 for indicating a currently logged in user. Screen portion 606 shows the currently selected image associated with a clip, in a large format, that may be retrieved from a target website's HTML document. Message 608 may confirm the price drop alert indicating what the current price is and what the target price and percentage that have been stored in the database are. Message 610 encourages the user to share the opportunity to utilize price drop alerts as part of the system. Mechanisms 628 allow the user to uniform other users about price drop alert functionality. In addition to various social media platforms, mechanism 628 allows the user to inform others via email or users of the system who already have user IDs stored in the database via an internal messaging system.

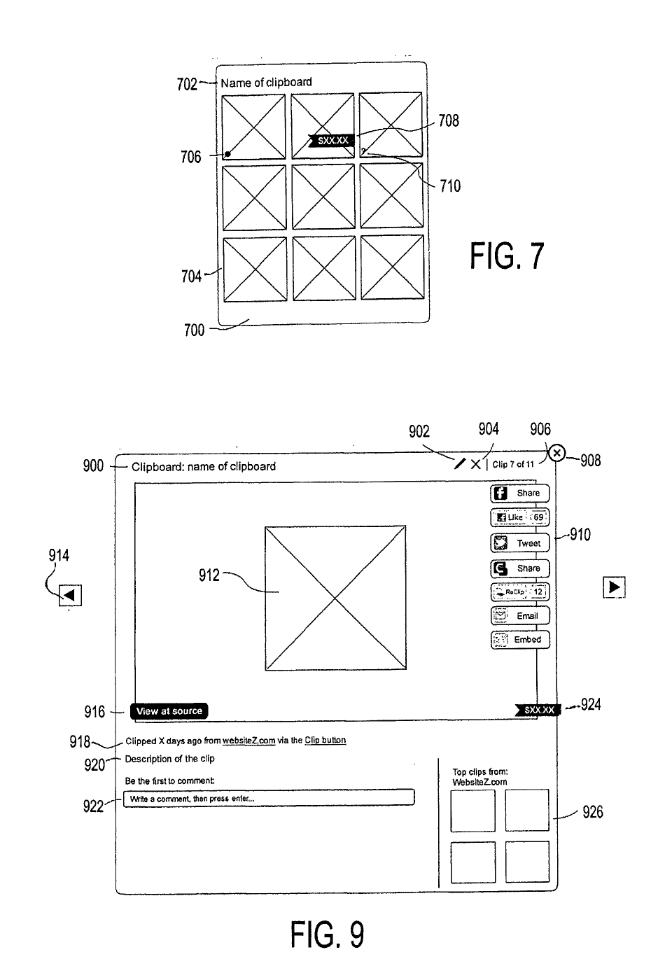

FIG. 7 is an exemplary screenshot of a clipboard containing clips with price drop alerts set in accordance with an embodiment of the subject matter described herein. Referring to FIG. 7, clipboard 700 may include name of the clipboard 702 as generated by the user. The clipboard 700 may include a plurality of individual clips 704. For clips that have activated the price drop alert feature, indicator 706, such as an orange circle, may indicate that a price drop alert has been set for the clip. Hovering the cursor over the indicator 706 activates a browser tooltip informing the user of the target price and the target percentage of the clip.

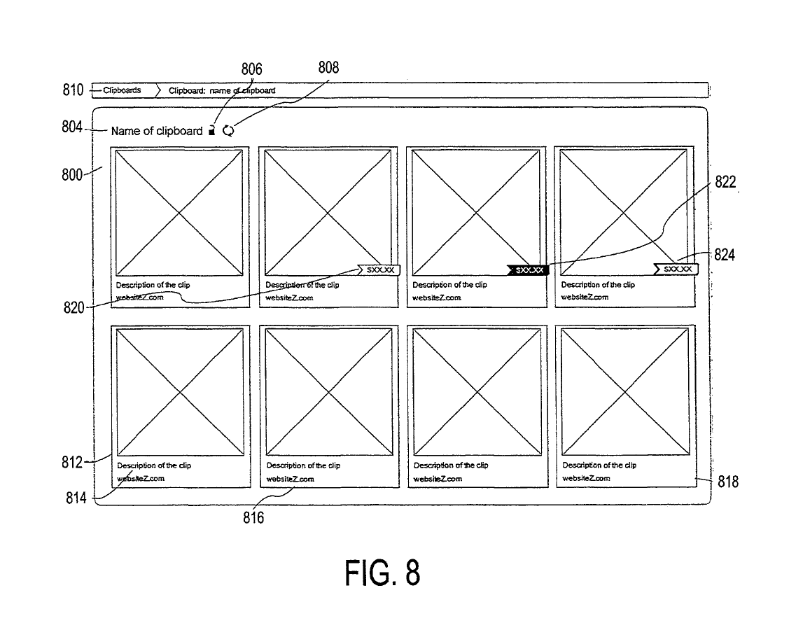

FIG. 8 is an exemplary screenshot of an expanded view of a clipboard containing clips with price drops alerts set in accordance with an embodiment of the subject matter described herein. Referring to FIG. 8, clipboard 800 may have a clipboard name 804. Mechanism 806 indicates the privacy of the clipboard 800 and allows the user to alter those settings. Exemplary privacy states include completely private, visible only to friends, or completely visible (i.e., public). Mechanism 808 indicates, and altering, whether the clipboard 800 has “Syncboard TM” status where the shared/synced clipboard is shared across multiple user IDs. Breadcrumb trail 810 assists in user navigation by indicating where the current page is organized within the hierarchy of the website.

The clipboard 800 may include a plurality of individual clips 812, where each clip 812 may include a description 814 of the clip which may be pre-populated from the source website's HTML page title or, alternately, may be user generated. Indicator 816 indicates the source of the clip and directs the user back (e.g., via a hyperlink), to the source website. Draggable portion 818 is an area of the clip that allows the user to reorder clips 812 on the clipboard 800.

Indicator 820 indicates a product or service associated with a clip where a price drop alert feature has not been set. For example, indicator 820 may include a white flag. Indicator 822 indicates that a price drop alert feature has been activated and that the target price has been reached. For example, indicator 822 may include a green flag. Hovering a cursor over indicator 822 may activate a browser tooltip informing the user of this information. Indicator 824 indicates that a price drop alert feature has been set for the clip and that the target price has not yet been reached. For example, indicator 824 may include an orange flag.

FIG. 9 is an exemplary screenshot of an individual clip with a price drop alert set in accordance with an embodiment of the subject matter described herein. Referring to FIG. 9, clipboard 900 may have a user-generated name displayed at the top of the clipboard. Mechanism 902 allows the user to edit the clip and directs the user to the screen shown in FIG. 11 described later. Indicator 906 indicates the user's location as it relates to the current clip versus the number of clips in the clipboard. For example, the clip shown in FIG. 9 is clip 7 out of 11 total clips. Mechanism 908 provides for closing the panel displaying the current clip. Mechanism 910 allows the user to share the clip across multiple different channels, such as social media websites.

Clip image 912 shows a large format image associated with the current clip and controls 914 allows the user to scroll backward or forward through the clips on the clipboard 900. Indicator 916 indicates the source of the clip and clicking on the indicator 916 directs the user back to the source website. Indicator 918 indicates when the clip was clipped and what source website it was clipped from. Description 920 includes a description of the clip which may be pre-populated from the source website's HTML page title or may be user-generated. Field 922 includes a free-form field that may be used by the clip owner or other users to comment on the clip. Indicator 924 indicates whether a target price has been reached. In the example shown, a green flag may be used to indicate that the target price has been reached while an orange flag may be used to indicate that, while a price drop alert has been set for the clip, the target price has not been reached. Screen portion 926 may display items from a source website that also appear in the database the greatest number of times. Thus, screen portion 926 may highlight other clips, products, or services that are related in some way to the current clip, are popular, and therefore may also be of interest to the user.

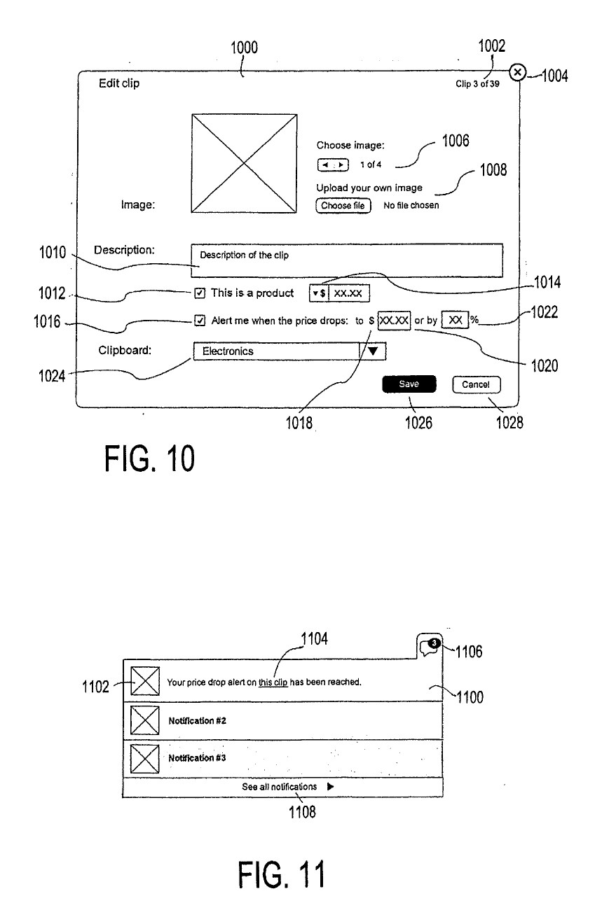

FIG. 10 is an exemplary screenshot of an interface for one of editing a clip, editing a price drop alert, or creating a new price drop alert in accordance with an embodiment of the subject matter described herein. Referring to FIG. 10, screen 1000 includes an interface for editing a clip. Indicator 1001 indicates the user's location as it relates to the current clip being editing versus the number of clips in the clipboard. Mechanism 1004 allows the user to close the current panel 1000 for editing the current clip. Mechanism 1006 allow for the user to call images from the source website's HTML page and select an image that will represent the clip. Mechanism 1008 allows the user to upload a file from their personal computer that will visually represent the clip.

Field 1010 includes a free-form field that may be used by the clip owner or other users to comment on the clip. Mechanism 1012 allows the user to manually indicate whether the item is a product and manually enter or overwrite the pre-populated price. Selector 1014 allows the user to select a currency as it relates to the price of the product. Selector 1016 includes a two-stage selector for indicating whether a price drop alert will be set for the clip. Indicator 1018 indicates the currency in which the price drop alert value will be stored to the database. Field 1020 includes a free-form field for entry of a user's target price. Field 1020 may be instantly and constantly synchronized with field 1022. Field 1022 include a free-form field for entry of a target percentage between the target price and the current price. Selector 1024 allows the user to choose which clipboard the clip will be uploaded to. Button 1026 allows the user to save all data entry and rewrite all modified fields to the database. Changed fields overwrite any previously stored information in the database. Button 1028 allows the user to cancel all data entry and maintain whatever data was previously stored in the database prior to modification.

FIG. 11 is an exemplary screenshot of various notifications including a notification that a target price has been reached in accordance with an embodiment of the subject matter described herein. Referring to FIG. 11, notifications 1100 may be displayed to the user, for example, in a stacked format. A portion 1102 of each notification 1100 may include an image representing the clip and a hyperlink 1104 included in notification 1100 may link to the page containing the clip, for which a price drop alert has been set, on the website that has reached the user's target price. The user may follow the source of the clip to return to the original source of the clip and purchase the product or service. Tab 1106 indicates a number of notifications currently in the user's notification center. Information for tab 1106 may be retrieved from the database. At the bottom of the screen, mechanism 1108 allows users to see a history of all notifications received in the last, including all previous notifications of price drop alert targets reached.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A method for providing an indication of a change in an online price, the method comprising:
receiving, from a user, a request for an indication of a change in an online price of a product or service;
determining an initial price of the product or service;
receiving, from the user, a target price of the product or service;
detecting a change in the price of the product or service; and
generating an indication of the change in the price of the product or service.

2. The method of claim 1 wherein determining an initial price of the product or service includes determining the price of the product or service at the time the request is received from the user, where the price is the price at which at least one provider of the product or service will provide the product or service to the user.

3. The method of claim 1 wherein determining an initial price of the product or service includes querying a database that includes pricing information for the product or service.

4. The method of claim 3 wherein the database is maintained by the provider of the product or service.

5. The method of claim 4 wherein querying the database includes sending an outward call to a web server associated with the database using an application program interface (API) interpretable by the web server.

6. The method of claim 1 wherein determining an initial price of the product or service includes examining hypertext markup language (HTML) code of a webpage indicated, by the user, as indicating the initial price.

7. The method of claim 1 comprising automatically generating the target price based on the initial price.

8. The method of claim 1 wherein receiving a target price includes receiving a price that is less than or equal to the current price.

9. The method of claim 1 wherein detecting a change in the price includes comparing the target price to the initial price.

10. The method of claim 1 wherein generating an indication of the change in the price includes generating one of an email, a simple message service message, a multimedia message service message, an audio indicator, and visual indicator.

11. The method of claim 10 wherein the visual indicator includes at least one of a first color for indicating that a change in the initial price was detected and the target price was reached, a second color for indicating that no change in the initial price was detected, and a third color for indicating that a change in the initial price was detected but the target price was not reached.

12. The method of claim 1 comprising presenting the indication of the change in the price to the user.

13. The method of claim 1 wherein the method is performed as part of a visual bookmarking organizational website.

14. The method of claim 13 wherein the product or service is associated with a visual bookmark associated with the visual bookmarking organizational website.

15. The method of claim 1 comprising:
receiving multiple requests from multiple users for an indication of a change in an online price of the same product or service;
combining the multiple requests into a single request and sending the single request to the provider of the product or service;
receiving a single response from the provider of the product indicating a change in the price of the product or service; and
automatically splitting the indication of the price change of the product or service into an individual indication of the price change of the product or service for each of the multiple users.

16. A system for providing an indication of a change in an online price, the system comprising:
a web server for:
receiving, from a user, a request for an indication of a change in an online price of a product or service;
providing a current price of the product or service;
receiving a target price of the product or service from the user;
detecting a change in the price of the product or service; and
generating an indication of the change in the price of the product or service.

17. A tangible, non-transitory computer-readable medium having stored thereon computer executable instructions that when executed by the processor of a computer perform steps comprising:
receiving, from a user, a request for an indication of a change in an online price of a product or service;
providing a current price of the product or service;
receiving a target price of the product or service from the user;
detecting a change in the price of the product or service; and
generating an indication of the change in the price of the product or service.
